(19) United States
(12) Patent Application Publication
(10) Pub. No.: US 2004/0160713 A1
(43) Pub. Date: Aug. 19, 2004

(54) Intelligent line switch

(76) Inventor: Jung-Tsung Wei, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/368,071

(22) Filed: Feb. 18, 2003

(51) Int. Cl. H02H 3/00

(52) U.S. Cl. 361/62

(57) ABSTRACT

An intelligent line switch and particularly a line switch equipped with an approaching or touching sensor, and an adjusting knob with a sensor of adjusting sensitivity. The line switch includes a switch operable in a manual mode or an automatic mode. The manual mode may control an electric device in a conventional way. When switched to the automatic mode, the sensor can detect approaching or touching of operator's hand. Thus operator can easily actuate operations of ON or OFF or adjustment of the electric device by merely a single motion such as approaching or touching with one hand without the complicated operations of approaching, grasping, depressing and leaving occurred to the conventional line switches.

### BACKGROUND OF THE INVENTION

1. Field of the Invention

The invention relates to a line switch equipped with an approaching or touch sensor for controlling electric devices by induction or also equipping conventional depressing operation.

2. Description of the Prior Art

The commonly used switches for controlling electric devices can be classified in wall switches, pulling switches, device switches directly mounted onto the electric devices or line switches installed on the power cord. The line switch 1, as shown in FIGS. 1 and 2, generally is installed on a power cord 2 that provides power supply to the electric device. It includes a button switch 11. Depressing the button switch 11 can control ON or OFF of the electric device.

The line switch set forth above adopts conventional manual operation. The operation usually includes the following steps:

1. Hand approaches the line switch 1 (as shown in FIG. 3) and prepares to grasp the line switch 1.

2. Hand grasps the line switch 1 (as shown in FIG. 4) and prepares to depress the button switch 11.

3. Thumb moves to the button switch 11 and depresses the button switch 11 (as shown in FIG. 5) to control or adjust ON or OFF of the electric device.

4. Finally, the thumb releases and the palm opens, the hand moves away from the line switch 1 (as shown in FIG. 6).

It takes many steps to operate and control the line switch 1. The operation procedures of hand grasping and finger depressing are primitive and cumbersome. They cannot achieve the control function instantly. In the event that the line switch 1 is suspended in the air, it tends to swing and is difficult to grasp. Moreover, some conventional line switch 1, besides offering the function of switching ON or OFF of the electric device, also can adjust light brightness or intensity of the electric device. The operation procedures of the button switch cannot fully meet such requirements.

### SUMMARY OF THE INVENTION

In view of the aforesaid disadvantages, the primary object of the invention is to provide an intelligent line switch that achieves control function in a simple and easy way to overcome the troubles and inconveniences of conventional line switches that involve the operations of approaching, grasping, depressing and leaving. According to the invention, the shell of the line switch houses an approaching or touch sensor to enable the line switch to equip approaching or touch control capability. When an user's hand approaches or touches the line switch, the sensor detects the approaching or touching hand, and can control or adjust ON or OFF of the electric device.

In one aspect of the invention, the line switch of the invention includes a manual/automatic mode switch to integrate the conventional button switch function so that the line switch may be selectively operated in the conventional button switch mode or the induction mode to control the electric device. The line switch thus constructed includes dual control functions.

In another aspect, the shell of the line switch may be made from metal or conductive plastics or other conductive materials with an inductive circuit connecting to the shell so that the shell also has induction capability. When human body approaches or touches the shell, the electric device may also be controlled.

In yet another aspect, a multi-stage control and adjustment of the electric device may be achieved by the distance of approaching hand or frequency or the elapsed time of the hand in contact with the touch sensor.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional line switch.

FIG. 2 is a schematic circuit diagram of a conventional line switch.

FIG. 3 is a schematic view of a conventional line switch in an operating condition.

FIG. 4 is a schematic view of a conventional line switch in another operating condition.

FIG. 5 is a schematic view of a conventional line switch in yet another operating condition.

FIG. 6 is a schematic view of a conventional line switch in still another operating condition.

FIG. 7 is a perspective view of the invention.

FIG. 8 is a schematic circuit diagram of the line switch of the invention.

FIG. 9 is a perspective view of a second embodiment the invention.

FIG. 10 is a schematic circuit diagram of the second embodiment the invention.

FIG. 11 is a perspective view of a third embodiment the invention.

FIG. 12 is a schematic circuit diagram of the third embodiment the invention.

FIG. 13 is a block diagram of a control device of the invention.

FIG. 14 is a block diagram of another embodiment of the control device of the invention.

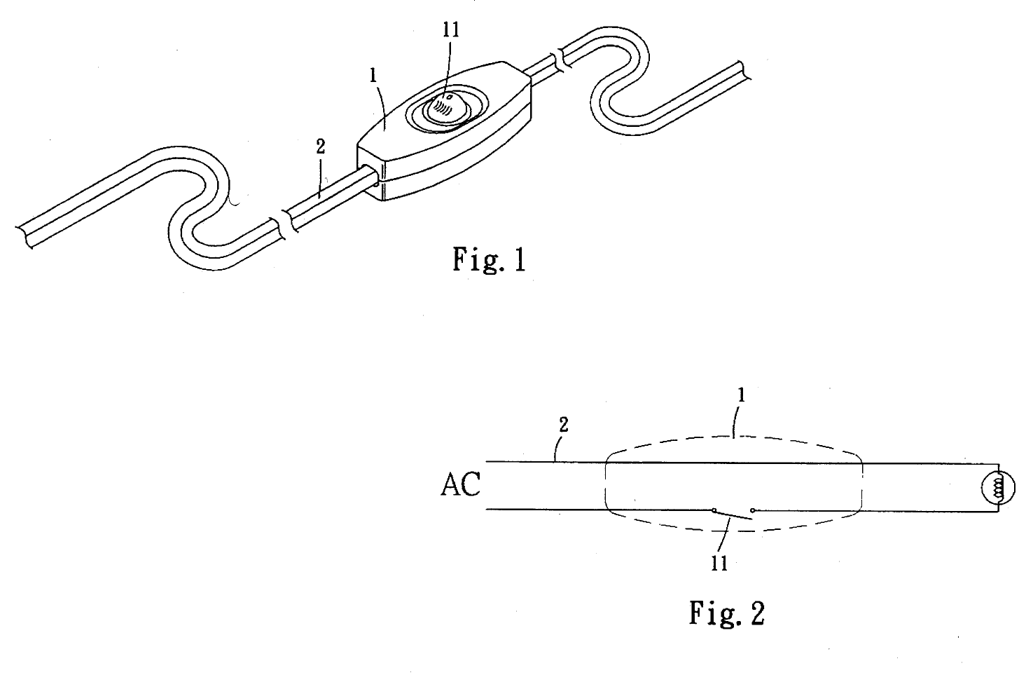

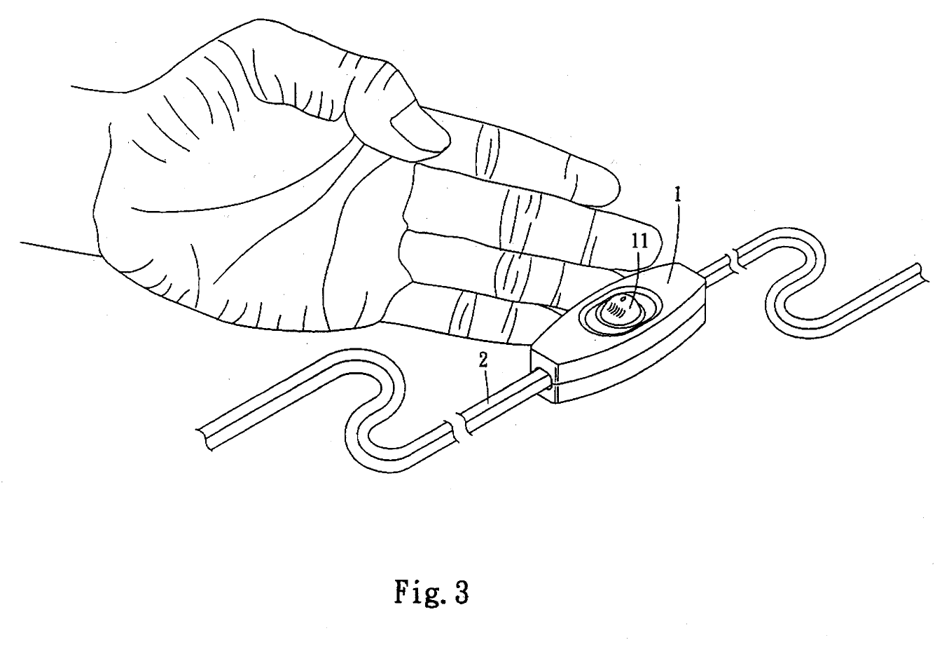

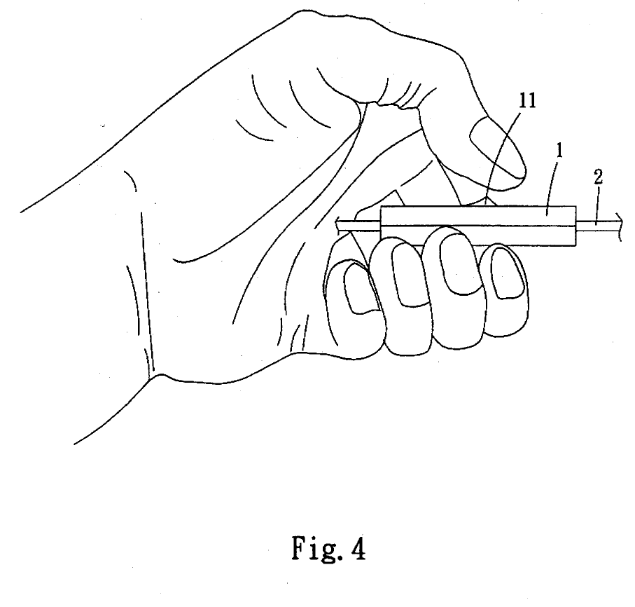

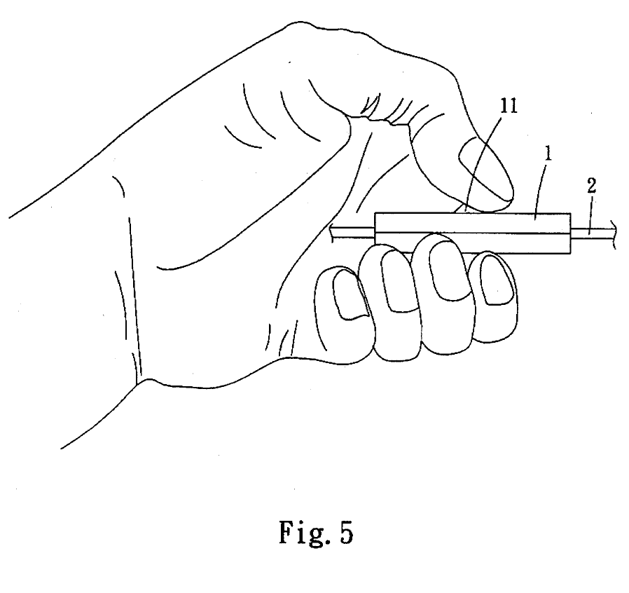

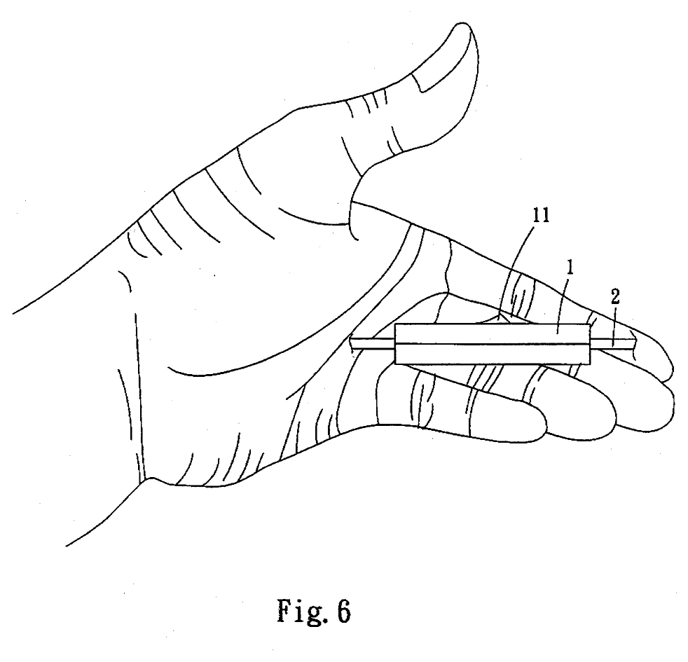

### DESCRIPTION OF THE PREFERRED EMBODIMENTS

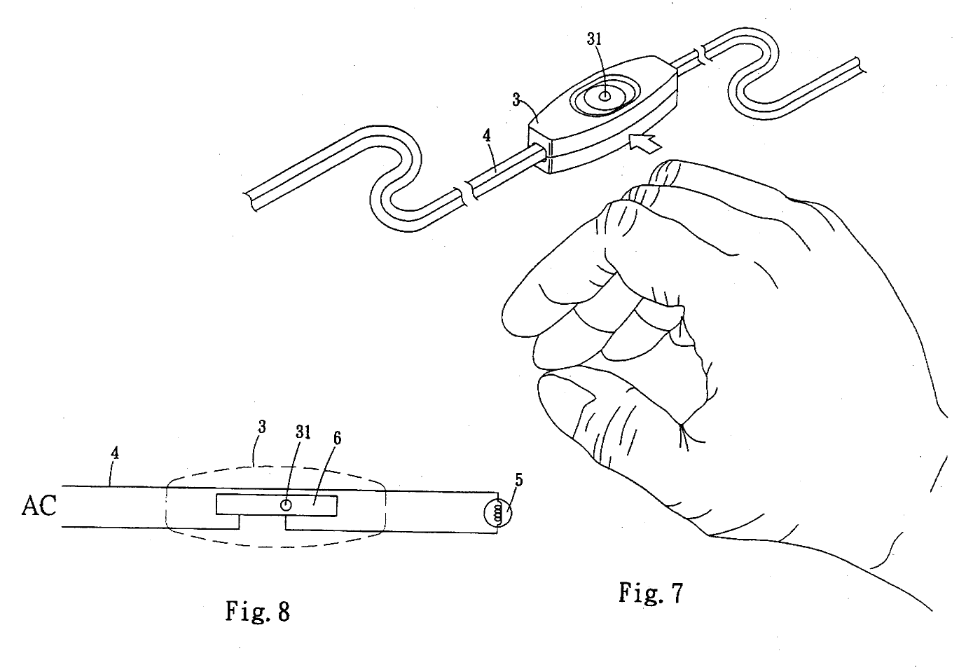

Referring to FIGS. 7 and 8, the line switch 3 of the invention includes a control device 6 located in a shell. The control device 6 has an inductive circuit. The inductive circuit has a sensor 31 sensible to approaching or touching of human body. The power cord 4 has one end connecting to the control device 6, then through the control device 6 connects to a load 5. When a user's hand approaches or touches the sensor 31 of the line switch 3, the sensor 31 transmits the detected signal to the control device 6 which controls ON or OFF of the electric device. Thus user does not need to take the complicated operation steps of approaching, grasping, depressing and leaving that occur to the conventional button line switch. Merely through the movement or posture of an approaching hand, the electric device may be controlled. Thus operation of the line switch 3 is much simpler and easier.

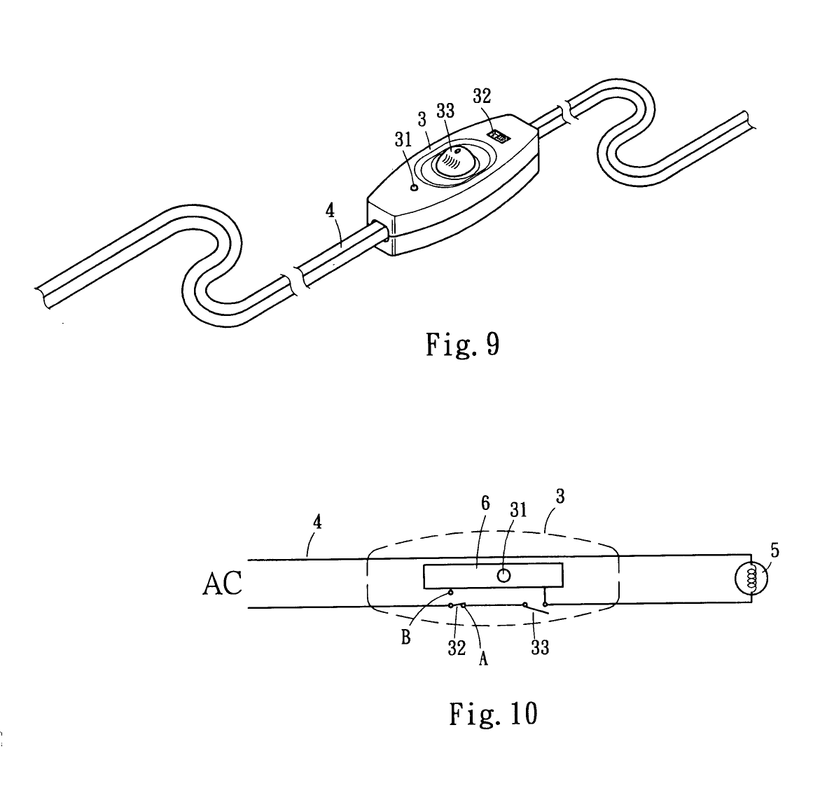

Referring to FIGS. 9 and 10 for another embodiment of the invention, the shell of the line switch 3 also includes a control device 6 which has a sensor 31 sensible to approaching or touching of human body. In addition, the line switch 3 includes a selection switch 32. The power cord 4 has one end connecting to the selection switch 32. The selection switch 32 has a contact B (for automatic control mode) connecting to the control device 6 and another contact A (for manual control mode) connecting to the contact of the original button switch 33 of the line switch 3. The original button switch 33 has another contact connecting to an output control end of the control device 6 and the load 5. Hence when the selection switch 32 is switched to the contact B, the line switch 3 is in the induction control mode. When the selection switch 32 is switched to the contact A, it is in the manual control mode and the original button switch 33 may be used to control ON or OFF of the load 5. By means of such a structure, the line switch 3 can integrate and concurrently equip manual and automatic control methods.

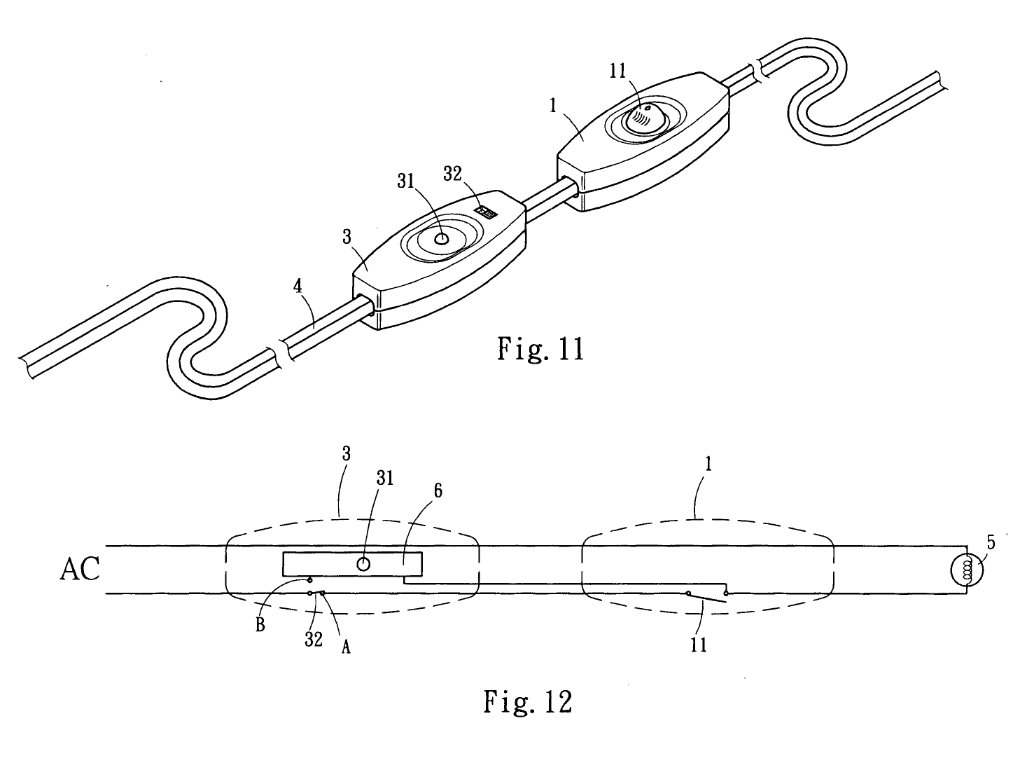

Referring to FIGS. 11 and 12 for yet another embodiment of the invention for the line switch 3 to integrate the conventional line switch 1 that equips with a button switch 11 and the induction control function. The line switch 3 of the invention includes a sensor 31 and a selection switch 32. The contact A of the selection witch 32 and the output control end of the control device 6 connect to two contacts of the switch of the line switch 1. Thus the conventional line switch 1 has inductive line switch 3 simultaneously. Therefore the original conventional line switch 1 also has inductive control function.

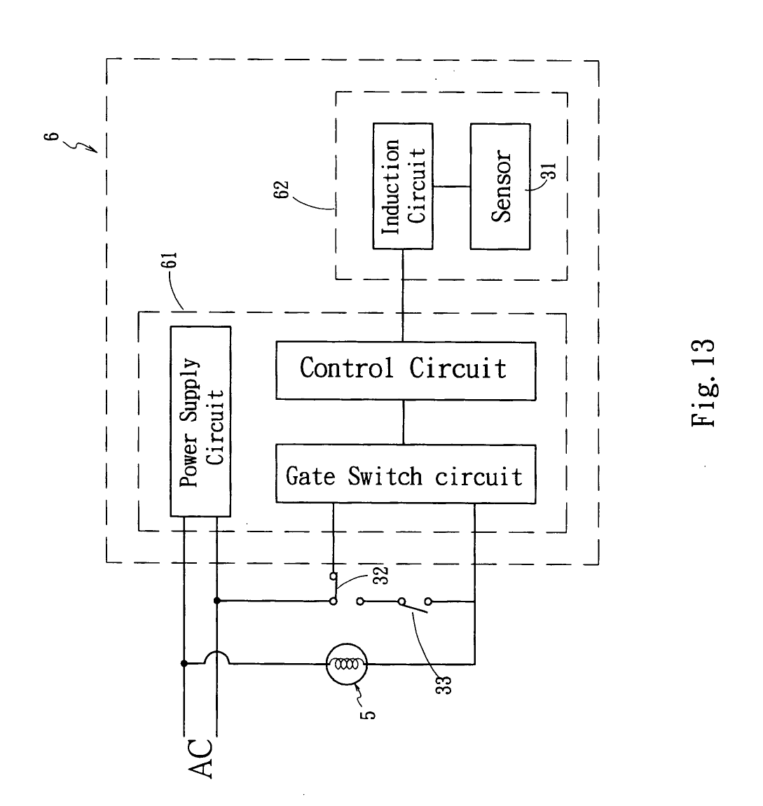

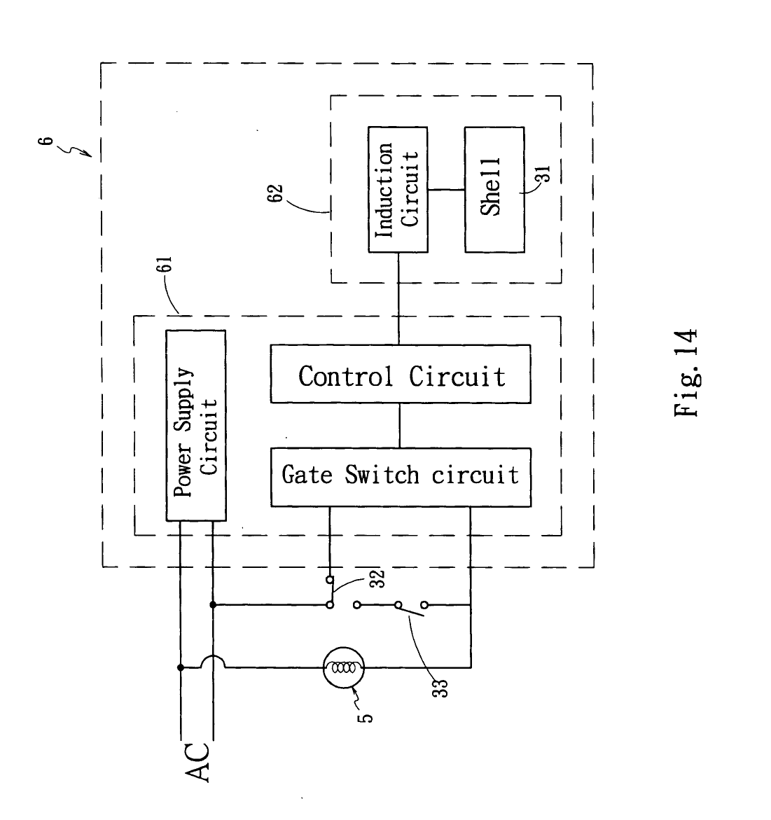

Referring to FIG. 13 for the control method of the control device 6. It mainly includes a control unit 61 and a sensor unit 62. The control unit 61 mainly consists of a power supply circuit, a control circuit and a gate switch circuit. The sensor unit 62 includes an induction circuit and a sensor 31. To equip the manual and automatic control modes concurrently on the line switch, two ends of the gate switch circuit are connected to a selection switch 32 and a button switch 33. Or as shown in FIG. 14, the inductive line switch of the invention originally has a sensor 31 to detect the approaching or touching of human body. The sensor 31 may be removed, and with the induction circuit directly connecting to the shell of the line switch 3 that is made from metal, or conductive plastics, or other conductive materials so that the shell becomes an inductive element with inductive capability. Thus when human body approaches the shell, the electric device may be inducted to accomplish the control object.

Furthermore, the control device 6 of the invention may also include a radio control device to enable the line switch 3 to control a remote load in a remote fashion. In addition, through hand approaching or touching frequency or elapsed time of touching on the sensor 31, a multiple-stage control or adjustment may be made for the electric device.

In summary, the invention overcomes the troubles of approaching, grasping, depressing and leaving operations occurred to conventional line switches, and controls electric devices by simply approaching the line switch in a short distance or touching the line switch. The operation and control is much simpler and easier.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An intelligent line switch comprising a shell and a control device housed in the shell, the control device including an inductive circuit which has a sensor sensible to approaching or touching of an object, the control device being connected to one end of a power cord which further connects to a load through the control device;
wherein the control device controls ON or OFF of the load through a single motion when an operator's hand approaches or touches the sensor.

2. The intelligent line switch of claim 1, wherein the power cord connects to a common contact of a selection switch for an automatic and a manual control modes before connecting to the control device, the automatic control mode having a first contact connecting to the control device, the manual control mode having a second contact connecting to a third contact located on one end of a button switch, the button switch having a fourth contact connecting concurrently to an output control end of the control device and the load.

3. The intelligent line switch of claim 1, wherein the shell is made from metal or selected conductive materials, the inductive circuit of the control device being connected to the shell so that the shell has induction capability to substitute the sensor.
